(19) United States
(12) Patent Application Publication
(10) Pub. No.: US 2014/0085151 A1
(43) Pub. Date: Mar. 27, 2014

(54) DEVICE AND COMMUNICATION DEVICE INCLUDING ANTENNA

(71) Applicants: HON HAI PRECISION INDUSTRY CO., LTD., New Taipei (TW); AMBIT MICROSYSTEMS (SHANGHAI) LTD., Shanghai (CN)

(72) Inventors: GUI-MIN YANG, Shenzhen (CN); CHUNG-KUN HOU, Tu-Cheng (TW)

(73) Assignees: HON HAI PRECISION INDUSTRY CO., LTD., New Taipei (TW); AMBIT MICROSYSTEMS (SHANGHAI) LTD., Shanghai (CN)

(21) Appl. No.: 14/029,819

(22) Filed: Sep. 18, 2013

(30) Foreign Application Priority Data
Sep. 26, 2012 (CN) 2012103628634

(51) Int. Cl. H01Q 1/24

(52) U.S. Cl. CPC H01Q 1/243
USPC 343/702

(57) ABSTRACT

A communication device includes a touch panel, a circuit board, and an antenna. The touch panel includes a non-touch area. The non-touch area is positioned at a border of the touch panel and being non-transparent. The circuit board is electronically connected to the touch panel and drives the communication device. The antenna is formed on a surface of the non-touch area by printing conductive ink on the surface of the non-touch area. The antenna is electronically coupled to the circuit board.

### BACKGROUND

1. Technical Field

The disclosure generally relates to a device and a communication device, and more particularly to a device and a communication device having an antenna.

2. Description of the Related Art

Antennas are widely used in wireless communication devices. A typical antenna is usually made of coil and packaged by an insulation film. The typical antenna is positioned in a case of communication device and electronically connected to a circuit board of the communication device. However, much space is needed to place the typical antenna, thus the communication device is thick. Moreover, the typical antenna cannot be flexibly placed.

Therefore, there is room for improvement within the art.

### BRIEF DESCRIPTION OF THE DRAWINGS

Many aspects of an exemplary communication device can be better understood with reference to the following drawings. The components in the drawings are not necessarily drawn to scale, the emphasis instead being placed upon clearly illustrating the principles of the exemplary communication device. Moreover, in the drawings, like reference numerals designate corresponding parts throughout the several views. Wherever possible, the same reference numbers are used throughout the drawings to refer to the same or like elements of an embodiment.

FIG. 1 is an isometric view of a communication device according to an exemplary embodiment of the present disclosure, the communication device includes a touch panel.

FIG. 2 is a complete assembled view of the communication device of FIG. 1.

FIG. 3 is a cross-sectional view of the communication device taken along line of III-III of FIG. 2

FIG. 4 is a back view of the touch panel of FIG. 1.

### DETAILED DESCRIPTION

Reference will be made to drawings to describe various embodiments.

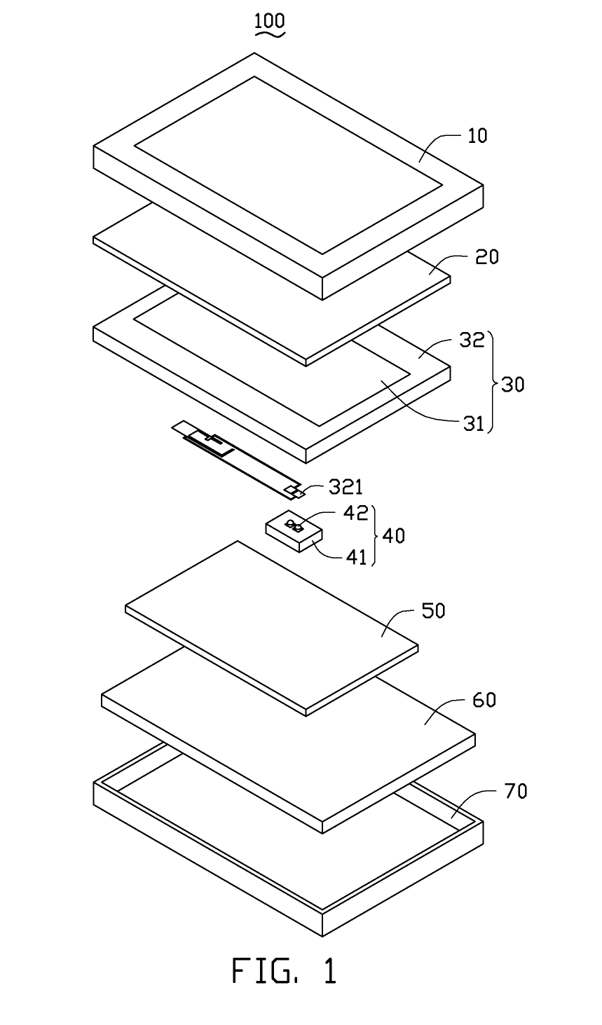

FIG. 1 is an isometric view of a communication device 100 according to an exemplary embodiment of the present disclosure. The communication device 100 includes a first frame 10, a cover glass 20, a touch panel 30, a connecting device 40, a circuit board 50, a battery 60 and a second frame 70. The first frame 10 cooperates with the second frame 70 to form a receiving space to receive the cover glass 20, the touch panel 30, the connecting device 40, the circuit board 50 and the battery 60. The battery 60, the circuit board 50, the connecting device 40, the touch panel 30 and the cover glass 20 are placed on the second frame 70 in that order.

The cover glass 20 protects the touch panel 30. The touch panel 30 includes a touch area 31 and a non-touch area 32. The touch area 31 receives touch operations of a user and generates touch signals according to the touch operations. The non-touch area 32 may be a border area of the touch panel 30 and extends from the touch area 31 and in a same horizontal plane as the touch area 31. The non-touch area 32 may be a non-transparent area.

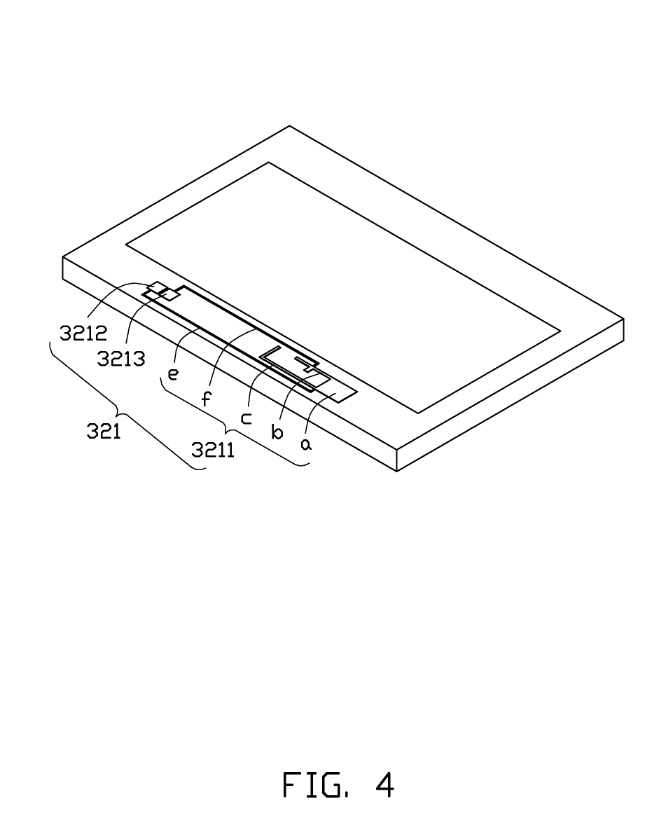

An antenna 321 is placed on a side of the non-touch area 32 near the circuit board 50. For example, a side of the non-touch area 32 may be away from the cover glass 20. The antenna 321 cooperating with the circuit board 50 perform communication with an external device (for example, a base station) using a specific frequency band of electromagnetic waves. FIG. 4 is a back view of the touch panel of FIG. 1. The antenna 321 includes a main part 3211, a first connection part 3212, and a second connection part 3213. The main part 3211 receives and sends electromagnetic waves. The first connection part 3212 and the second connection part 3213 are electronically coupled to the circuit board 50 via the connecting device 40. In the embodiment, the first connection part 3212 and the second connection part 3213 have a same shape, for example rectangle. The main part 3211 includes a radiation part “a”, a first signal feedback part “b”, a second signal feedback part “c”, a first wire “e” and a second wire “f”. The radiation part “a” sends and receives electromagnetic waves. In the embodiment, the radiation part “a” is also in a rectangle shape. The first signal feedback part “b” and the second signal feedback part “c” extend from a same side of the radiation part “a”, and the first signal feedback part “b” and the second signal feedback part “c” transmit electromagnetic waves received or sent by the radiation part “a”. The first signal feedback part “b” and the second feedback part “c” are similar to “L” shape. The first wire “e” is electronically connected the first connection part 3212 and the second signal feedback part “c”. The second wire “f” is electronically connected the second connection part 3213 and the first feedback part “b”. In the embodiment, the antenna 321 is form by printing process. In detail, the antenna 321 is formed by printing conductive ink on a surface of the non-touch area 32. In other embodiments, the antenna 321 can be formed in a same process of sensor patterns (not shown) of the touch area 31. Thus, process of forming the antenna 321 can be simplified. In one exemplary embodiment, the antenna 321 may be formed by the following method: printing electronically conductive ink on the non-touch area 32 a predetermined thickness and patterning the conductive ink to form the antenna 321 that the antenna 321 is integrated on the non-touch area 32.

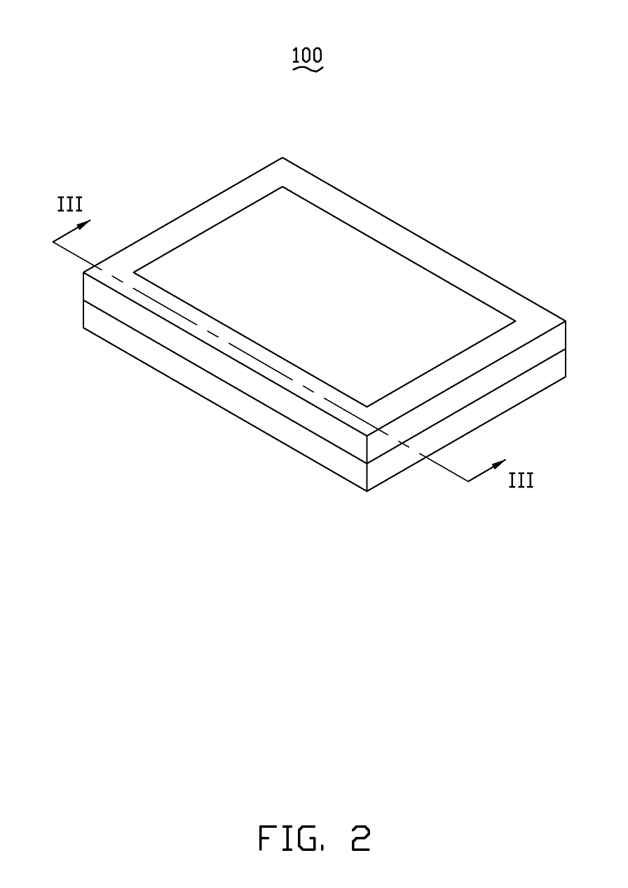

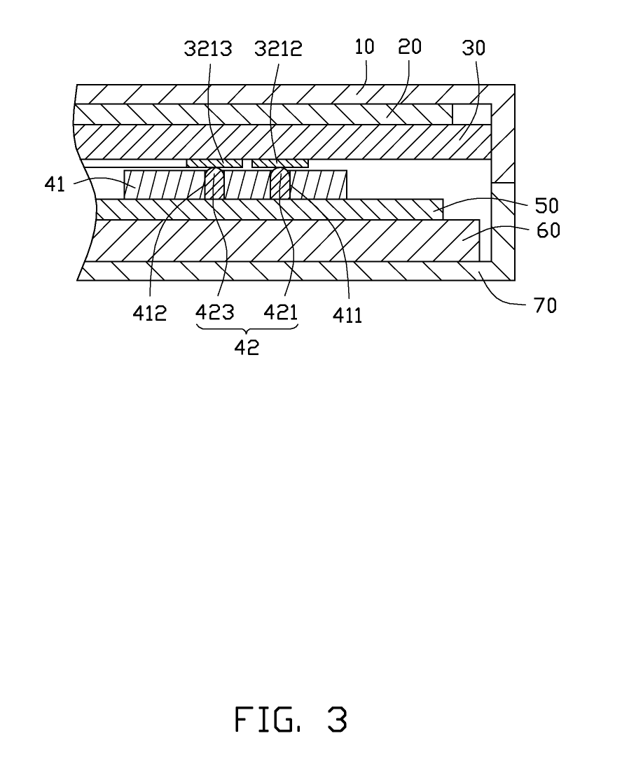

FIGS. 1-3 show that the connecting device 40 includes a main body 41 and a connection portion 42. The main body 41 is made of an insulation material and the connection portion 42 is made of a conductive material, for example metal. The connective device 40 is electronically connected the antenna 321 to the circuit board 50. The main body 41 is positioned near the circuit board 50 and supports the connection portion 42. The connection portion 42 is positioned near the antenna 321 and electronically connected the antenna 321 to the circuit board 50.

The main body 41 includes a first through hole 411 and a second through hole 412. The connection portion 42 includes a first connection sub-portion 421 and a second connection sub-portion 423. Part of the first connection sub-portion 421 is accommodated in the first through hole 411 and the remainder of the first connection sub-portion 421 can be exposed out of the first through hole 411. Part of the second connection sub-portion 423 is accommodated in the second through hole 412 and the remainder of the second connection sub-portion 423 can be exposed out of the second through hole 412. When the communication device is assembled, the first connection sub-portion 421 is electronically connected to the first connection part 3212 of the antenna 321 to the circuit board 50. The second connection sub-portion 423 is electronically connected to the second connection part 3213 of the antenna 321 to the circuit board 50. Thus, electromagnetic wave can be transmitted between the antenna 321 and the circuit board 50 of the communication device 100.

In the embodiment, the first connection sub-portion 421 is vertically connected to the first connection part 3212, and the second connection sub-portion 423 is also vertically connected to the second connection part 3213. Thus, a distance between the antenna 321 and the connecting device 40 is shorter than a distance between the antenna 321 and the connecting device 40 when at least one of the first connection sub-portion 421 is not vertically connected to the first connection part 3212 and the second connection sub-portion 423 is not vertically connected to the second connection part 3213, that the communication device 100 can be made thinner than the communication device 100 when at least one of the first connection sub-portion 421 is not vertically connected to the first connection part 3212 and the second connection sub-portion 423 is not vertically connected to the second connection part 3213. Part of the first connection sub-portion 421 and part of the second connection sub-portion 423 adjacent to the antenna 321 are arc shaped, and this shape can make the connecting device 40 electronically connect to the antenna. Further, the first connection sub-portion 421 and the second connection sub-portion 423 can be deformed when a gap between the connecting device 40 and the touch panel 30, thus damage to the touch panel 30 can be avoided.

The circuit board 50 is electronically connected to the touch panel 30 and the drives the communication device 100. The battery 50 provides a driving voltage to the circuit board 50.

In the present disclosure, the antenna 321 is formed on a surface of the non-touch area 32 by a printing process. Moreover, the antenna 321 can be formed on anywhere of the non-touch area 32 flexibly.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A communication device, comprising:
a touch panel having a touch area and a non-touch area, the touch area receiving touch operations of a user, the non-touch area extending from the touch area and being a non-transparent area;
a circuit board electronically connected to the touch panel and driving the communication device; and
an antenna formed on a surface of the non-touch area, the antenna electronically coupled to the circuit board.

2. The communication device according to claim 1, wherein the antenna is formed by printing conductive ink on a surface of the non-touch area.

3. The communication device according to claim 1, wherein the antenna is formed on a surface of the non-touch area adjacent to the circuit board.

4. The communication device according to claim 1, further comprising a cover glass, the cover glass placed on a side of the touch panel which is away from the antenna.

5. The communication device according to claim 1, further comprising a connecting device, the connecting device comprising a main body made of an insulation material and a connection portion made of a conductive material, wherein the main body supports the connection portion; the connection portion electronically connected the antenna to the circuit board.

6. The communication device according to claim 5, wherein the main body comprises a first through hole; the connection portion comprises a first connection sub-portion; a part of the first connection sub-portion is accommodated in the first through hole and a remainder of the first connection sub-portion is exposed out of the first through hole to connect the antenna.

7. The communication device according to claim 6, wherein the part of the first connection sub-portion exposed out of the first through hole is arc shaped.

8. The communication device according to claim 6, wherein the antenna comprises a main part, and a first connection part; the main part receives and sends electromagnetic wave; the first connection part is electronically coupled to the circuit board via the first connection sub-portion.

9. The communication device according to claim 8, wherein the connection portion further comprises a second connection sub-portion, the antenna further comprises a second connection part, the second connection part electronically coupled to the circuit board via the second connection sub-portion, and the first connection part and the second connection part have a same shape.

10. The communication device according to claim 8, wherein the main part comprises a radiation part, a first signal feedback part, a second signal feedback part, a first wire, and a second wire; the radiation part sends and receives electromagnetic wave, the first signal feedback part and the second signal feedback part extend from a same side of the radiation part and transmit electromagnetic waves received or sent by the radiation part; the first wire is electronically connected the second feedback part to the first connection part, the second wire is electronically connected to the first feedback part to the second connection part.

11. A communication device, comprising:
a touch panel having a non-transparent area being positioned at a border of the touch panel;
a circuit board electronically connecting to the touch panel and driving the communication device; and
an antenna printed on a surface of the non-transparent area and being electronically coupled to the circuit board.

12. A device, comprising:
a touch substrate having a touch function, the touch substrate comprising a touch area and a non-touch area, the touch area receiving touch operation of a user;
a circuit board electronically connected to the touch panel and driving the communication device; and
an antenna integrated on the non-touch area of the touch substrate by printing conductive ink on the non-touch area at a predetermined thickness and patterning the conductive ink.

13. The device according to claim 12, wherein the antenna is formed on a surface of the non-touch area adjacent to the circuit board.

14. The device according to claim 12, further comprising a cover glass, the cover glass being placed on a side of the touch substrate which is away from the antenna.

15. The device according to claim 12, further comprising a connecting device, the connecting device comprising a main body made of an insulation material and a connection portion made of a conductive material, wherein the main body supports the connection portion, the connection portion electronically connected the antenna to the circuit board.

16. The device according to claim 15, wherein the main body comprises a first through hole, the connection portion comprises a first connection sub-portion, a part of the first connection sub-portion is accommodated in the first through hole and the remainder of the first connection sub-portion is exposed out of the first through hole to connect the antenna.

17. The device according to claim 16, wherein the part of the first connection sub-portion exposed out of the first through hole is arc shaped.

18. The device according to claim 16, wherein the antenna comprises a main part, and a first connection part; the main part receives and sends electromagnetic wave; the first connection part is electronically coupled to the circuit board via the first connection sub-portion.

19. The device according to claim 18, wherein the connection portion further comprises a second connection sub-portion, the antenna further comprises a second connection part, the second connection part electronically coupled to the circuit board via the second connection sub-portion, and the first connection part and the second connection part have a same shape.

20. The device according to claim 18, wherein the main part comprises a radiation part, a first signal feedback part, a second signal feedback part, a first wire and a second wire; the radiation part seconds and receives electromagnetic wave, the first signal feedback part and the second signal feedback part extend from a same side of the radiation part and transmit electromagnetic waves received or sent by the radiation part, the first wire is electronically connected the second feedback part to the first connection part, the second wire is electronically connected to the first feedback part to the second connection part.
